(19) United States
(12) Patent Application Publication
(10) Pub. No.: US 2003/0181182 A1
(43) Pub. Date: Sep. 25, 2003

(54) Receiver for wireless transmission system

(76) Inventor: Ho Sing Hoi, Kowloon (HK)

Correspondence Address: JENKENS & GILCHRIST, P.C., 225 WEST WASHINGTON, SUITE 2600, CHICAGO, IL, 60606, US

(21) Appl. No.: 10/104,646

(22) Filed: Mar. 22, 2002

(51) Int. Cl. H04B 7/00

(52) U.S. Cl. 455/258; 455/260; 455/255

(57) ABSTRACT

A receiver for use in a wireless audio transmission system includes a first voltage-controlled oscillator (“1st VCO”) for generating a first local oscillator (“1st LO”) signal, a down converter responsive to the first LO signal for converting a received high-frequency signal into a 1st IF signal having a frequency determined in part by the 1st LO signal, a reference signal source for generating a first reference signal, a second voltage-controlled oscillator (“2nd VCO”) responsive to the first reference signal for generating a second reference signal having a desired frequency for the 1st LO signal, a first phase-locked loop (“1st PLL”) responsive to the first and second reference signals for controlling the 2nd VCO to synchronize the phase of the first and second reference signals, and a second phase-locked loop (“2nd PLL”) responsive to the 1st LO signal and the second reference signal for controlling the 2nd VCO to synchronize the phase of the 1st LO signal with that of the second reference signal

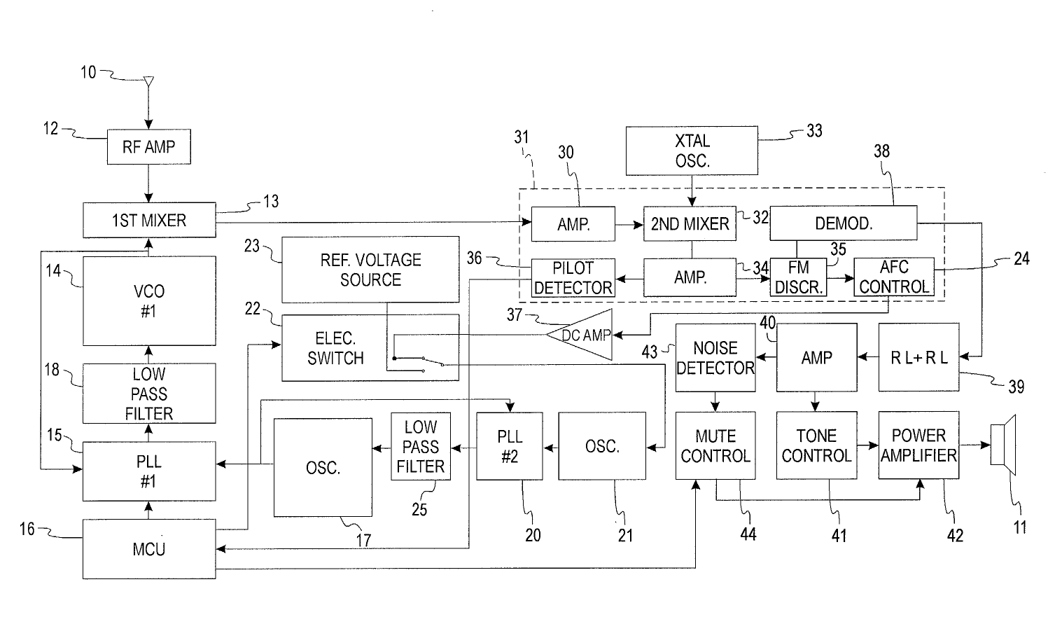

### FIELD OF THE INVENTION

The present invention relates generally to receivers for use in wireless transmission systems for short-range transmission of analog signals using high-frequency carrier signals at low power levels.

### BACKGROUND OF THE INVENTION

Wireless systems for transmission of audio signals from a central source such as a home stereo system to speakers located within a short range of the source are in common use.

### SUMMARY OF THE INVENTION

In accordance with the present invention, there is provided a receiver for use in a wireless audio transmission system, comprising

a first voltage-controlled oscillator (“1st VCO”) for generating a first local oscillator (“1st LO”) signal,

a down converter responsive to the first LO signal for converting a received high-frequency signal into a 1st IF signal having a frequency determined in part by the 1st LO signal,

a reference signal source for generating a first reference signal,

a second voltage-controlled oscillator (“2nd VCO”) responsive to the first reference signal for generating a second reference signal having a desired frequency for the 1st LO signal,

a first phase-locked loop (“1st PLL”) responsive to the first and second reference signals for controlling the 2nd VCO to synchronize the phase of the first and second reference signals, and

a second phase-locked loop (“2nd PLL”) responsive to the 1st LO signal and the second reference signal for controlling the 2nd VCO to synchronize the phase of the 1st LO signal with that of the second reference signal.

A preferred embodiment of the receiver also includes

an automatic frequency control (“AFC”) signal,

a detector for a pilot signal in the received signal, and

a switch for substituting said AFC signal for said second reference signal in response to the absence of a pilot signal.

### BRIEF DESCRIPTION OF THE DRAWING

The invention may best be understood by reference to the following description taken in conjunction with the accompanying drawing, in which the single FIGURE is a block diagram of a receiver embodying the present invention.

### DETAILED DESCRIPTION OF PREFERRED EMBODIMENTS

Although the invention will be described in connection with certain preferred embodiments, it will be understood that the invention is not limited to those particular embodiments. On the contrary, the invention is intended to include all alternatives, modifications and equivalent arrangements as may be included within the spirit and scope of the invention as defined by the appended claims.

Turning now to the drawings, the single FIGURE is a block diagram of a receiver for use with a transmitter that transmits analog signals at low power on a carrier frequency in the 900-MHz range (902.8-926.8 MHz). The purpose of the receiver is to convert the signals received by an antenna 10 to appropriate output signals for driving stereo speakers 11, which may be loudspeakers, earphones, or any desired audio transducers.

The transmitted signals picked up by the antenna 10 are supplied via an RF amplifier 12 and one or more filters (not shown) to a first mixer 13 that down-converts the received signals to a first IF frequency such as 75.918 MHz. The amplifier 12 increases the signal level sufficiently to drive the mixer 13, which also receives a first local oscillator signal (“1st LO signal”) from a first voltage-controlled oscillator (“1st VCO”) 14 controlled by a first phase-locked loop (“1st PLL”) 15. The 1st VCO 14 can be set to produce any of three different local oscillator frequencies (e.g., 835.732, 837.007 or 837.982 MHz) for down converting any of three modulated carrier frequencies (within the range 902.8 to 926.8 MHz) to the first IF frequency. The three carrier frequencies represent three transmission channels that can be selected by the user. Typically a three-position switch is provided on the front of the receiver chassis to permit the user to select one of the three channels, and the setting of this switch controls an input signal to a microprocessor unit (“MPU”) 16 connected to the 1st PLL 15. The MPU 16 responds to the input signal from the selector switch by producing a tuning signal that controls the 1st PLL 15 to produce a frequency corresponding to the selected channel.

The 1st PLL 15 supplies the 1st VCO 14 with a control signal that causes the VCO 14 to produce the local oscillator frequency required to down convert the selected channel (frequency) to the desired first IF frequency. Specifically, the local oscillator frequency is offset from the carrier frequency corresponding to the selected channel by an offset frequency that is equal to the desired first-IF frequency, e.g., 75.918 MHz. For example, the carrier frequency for the first channel is 911.650 MHz, and thus the 1st LO frequency of 835.732 MHz is required when the first channel is selected, to convert that channel to the desired 75.918-MHz 1st IF frequency.

In order to maintain the desired 1st LO frequency from the 1st VCO 14, the VCO output is fed back to the 1st PLL 15, which compares the phase of the 1st VCO output with that of a reference signal (e.g., 2.6388 MHz) from an oscillator 17. The PLL 15 generates a phase error signal corresponding to the result of the comparison, and this phase error signal is converted to a tuning voltage signal by an active low-pass filter 18. The output of the filter 18 is fed to the 1st VCO 14 as a control voltage that adjusts the oscillation frequency of the 1st VCO output as required to convert the selected-channel carrier frequency to the desired 1st IF frequency of 75.918 MHz.

In accordance with one aspect of the present invention, the reference signal oscillator 17 is controlled by a second phase-locked loop (“2nd PLL”) 20 which receives the output of the oscillator 17 as a feedback signal. The phase of this feedback signal is compared with that of the output of an oscillator 21 whose frequency is controlled by a control signal from a switch 22 controlled by the MPU 16. The switch 22 determines whether the oscillator 21 receives a fixed control signal from a source 23 or an automatic frequency control (“AFC”) signal from an AFC signal source 24. Regardless of which control signal is received by the oscillator 21, the PLL 20 compares the phase of this oscillator output with that of the output of the reference signal oscillator 17. The PLL 20 generates a phase error signal corresponding to the result of the comparison, and this phase error signal is converted to a tuning voltage signal by an active low-pass filter 25. The output of the filter 25 is fed to the oscillator 17 as a control voltage that adjusts the oscillation frequency of the oscillator 17 to the desired frequency represented by the control signal fed to the oscillator 21.

The normal position of the switch connects the oscillator 21 to the fixed reference voltage source 23. This reference voltage is selected to correspond to the AFC signal generated when the received signal is properly centered in the IF passband. When the MCU activates the switch 22 to connect the AFC signal from source 24 to the oscillator 21, the output frequencies of both the oscillator 21 and the oscillator 17 vary as a function of the AFC signal. Thus, the reference signal supplied by oscillator 17 to the 1st PLL 15 causes the output of the PLL 15, and thus the output of the 1st VCO 14, to automatically adjust as required to maintain the desired second IF frequency, as discussed below.

The 75.918-MHz, first-IF output of the mixer 13 is supplied to an amplifier 30 that is part of an integrated circuit 31, such as the IC CXA1538 made by Sony. The integrated circuit 31 provides a second down converter that converts the first-IF signal to a second-IF signal having a frequency of 10.7 MHz. This second down converter includes a second mixer 32 that receives the output of the amplifier 30 and a second local oscillator signal (“2nd LO signal”) from a crystal oscillator 33 running at 65.218 MHz. The mixing of the 75.918-MHz, first-IF signal with the 65.218-MHz local oscillator signal produces the desired 10.7-MHz second IF signal as the output from the mixer 32. This is a typical input frequency for audio systems.

The 10.7-MHz, second-IF signal is fed to an amplifier 34 to boost the output of the mixer, and then the amplifier output is fed to both an FM discriminator 35 and a pilot tone detector 36. The discriminator 35 supplies an output signal to a multiplexed audio signal decoder 36 and also supplies a signal to the AFC control circuit 24. The AFC circuit 24 detects any difference between the desired 10.7-MHz center frequency and the actual center frequency of the 2nd IF signal detected by the discriminator 35. This is typically accomplished by comparing the discriminator output with two reference signals, one of which is higher than, and the other of which is lower than, the desired frequency. If the discriminator output is between the two reference signals, no compensation is required. If the discriminator is below the lower reference signal or above the higher reference signal, the AFC control circuit 24 sends an output signal through a DC amplifier 37 to the switch 22 that controls whether the AFC signal is applied to the oscillator 21. When the AFC signal is applied to the oscillator 21, it adjusts the frequency of that oscillator, and hence the 1st LO signal, to adjust the center frequency of the 1st IF signal by the amount needed to maintain the center frequency of the 2nd IF signal at 10.7 MHz. That is, the oscillator 21 responds to the DC signal from the amplifier 37 to adjust its frequency to minimize that DC signal.

The pilot tone detector 36 detects a fixed-frequency signal (typically 25 KHz) that is built into the transmitted signal, and supplies a signal to he MCU to indicate whether or not the pilot tone has been detected. If the 1st LO and/or the 2nd LO have drifted so far from their desired frequencies that the pilot tone cannot be detected, the MCU adjusts the frequency of the VCO 14 until the pilot tone is detected. The AFC signal then takes over to maintain the 2nd-IF center frequency at 10.7 MHz.

The output of the discriminator 36 varies in proportion to the composite stereo FM modulation applied to the transmitted signal received by the antenna 10. To recover the left and right channel stereo signals for the desired audio output via speakers 11, the output of the discriminator 36 is fed through a stereo decoder or demodulator 38, which is typically an integrated circuit that is commercially available. The individual left and right audio signals from the decoder 38 are filtered to remove the pilot tone, and then fed through a conventional amplifier 40, tone control circuit 41 and power amplifier 42 to the speakers 11. The amplifier 40 also supplies a signal to a conventional noise detector 43 connected to a mute control circuit 44 connected to the power amplifier 42. The audio output can be muted at any time by turning off the power amplifier 42 in response to a signal supplied to the mute control circuit 44 from either the noise detector 43 or the MCU 16. For example, the MCU typically mutes the output when the pilot tone is not detected.

1. A receiver for use in a wireless audio transmission system, comprising
a first voltage-controlled oscillator (“1st VCO”) for generating a first local oscillator (“1st LO”) signal,
a down converter responsive to said 1st LO signal for converting a received high-frequency signal into a 1st IF signal having a frequency determined in part by said 1st LO signal,
a reference signal source for generating a first reference signal,
a second voltage-controlled oscillator (“2nd VCO”) responsive to said first reference signal for generating a second reference signal having a desired frequency for said 1st LO signal,
a first phase-locked loop (“1st PLL”) responsive to said 1st LO signal and said second reference signal for controlling said 1st VCO to synchronize the phase of said 1st LO signal with that of said second reference signal, and
a second phase-locked loop (“2nd PLL”) responsive to said first and second reference signals for controlling said 2nd VCO to synchronize the phase of said first and second reference signals.

2. The receiver of claim 1 which includes
means for generating an automatic frequency control (“AFC”) signal,
means for detecting a pilot signal in the received signal, and
means responsive to the absence of a pilot signal for substituting said AFC signal for said second reference signal.

3. The receiver of claim 1 which includes
a third voltage-controlled oscillator (“3rd VCO”) for generating a second local oscillator (“2nd LO”) signal,
a second down converter responsive to said 2nd LO signal for converting said 1st IF signal into a 2nd IF signal having a frequency determined in part by said 2nd LO signal, and
a second reference signal source for generating a third reference signal having a desired frequency for said 2nd LO signal.

4. The receiver of claim 3 which includes
means for generating an automatic frequency control (“AFC”) signal in response to said 2nd IF signal,
means for detecting a pilot signal in the received signal, and
means responsive to the absence of a pilot signal for substituting said AFC signal for said second reference signal.

5. The receiver of claim 4 which includes
an FM discriminator receiving said 2nd IF signal and producing a control signal for said AFC signal generating means.

6. A method of receiving signals in a wireless audio transmission system, comprising
generating a first local oscillator (“1st LO”) signal from a first voltage-controlled oscillator (“1st VCO”),
using said 1st LO signal to convert a received high-frequency signal into a 1st IF signal having a frequency determined in part by said 1st LO signal,
generating a first reference signal,
supplying said first reference signal to a second voltage-controlled oscillator (“2nd VCO”) to generate a second reference signal having a controlled frequency,
controlling said 1st VCO to synchronize the phase of said 1st LO signal with that of said second reference signal with a second phase-locked loop (“1st PLL”) responsive to said 1st LO signal and said second reference signal, and
controlling said 2nd VCO to synchronize the phase of said first and second reference signals with a first phase-locked loop (“2nd PLL”) responsive to said first and second reference signals for, and

7. The method of claim 6 which includes
generating an automatic frequency control (“AFC”) signal,
detecting a pilot signal in the received signal, and
substituting said AFC signal for said second reference signal in response to the absence of a pilot signal.

8. The method of claim 6 which includes
generating a second local oscillator (“2nd LO”) signal with a third voltage-controlled oscillator (“3rd VCO”),
converting said 1st IF signal into a 2nd IF signal having a frequency determined in part by said 2nd LO signal with a second down converter responsive to said 2nd LO signal, and
generating a third reference signal having a desired frequency for said 2nd LO signal.

9. The method of claim 8 which includes
generating an automatic frequency control (“AFC”) signal in response to said 2nd IF signal,
detecting a pilot signal in the received signal, and
substituting said AFC signal for said second reference signal in response to the absence of a pilot signal.

10. The method of claim 9 which includes
producing a control signal for said AFC signal generating means with an FM discriminator receiving said 2nd IF signal.
